(19) United States
(12) Patent Application Publication
(10) Pub. No.: US 2024/0202933 A1
(43) Pub. Date: Jun. 20, 2024

(54) LEARNING APPARATUS, ESTIMATION APPARATUS, LEARNING MODEL DATA GENERATION METHOD, ESTIMATION METHOD AND PROGRAM

(71) Applicant: NIPPON TELEGRAPH AND TELEPHONE CORPORATION, Tokyo (JP)

(72) Inventors: Takasuke NAGAI, Musashino-shi, Tokyo (JP); Shoichiro TAKEDA, Musashino-shi, Tokyo (JP); Masaaki MATSUMURA, Musashino-shi, Tokyo (JP); Shinya SHIMIZU, Musashino-shi, Tokyo (JP); Susumu YAMAMOTO, Musashino-shi, Tokyo (JP)

(73) Assignee: NIPPON TELEGRAPH AND TELEPHONE CORPORATION, Tokyo (JP)

(21) Appl. No.: 18/287,156

(22) PCT Filed: May 19, 2021
(86) PCT No.: PCT/JP2021/018964

§ 371 Date: Oct. 16, 2023

(51) Int. Cl. G06T 7/194; G06T 7/20; G06V 10/774

(52) U.S. Cl. CPC G06T 7/194; G06T 7/20; G06V 10/774

(57) ABSTRACT

Learning model data of a learning model that inputs original video data in which a background and a motion of a competitor are recorded, competitor mask video data in which an area surrounding the competitor is masked in each of a plurality of image frames included in the original video data, and background mask video data in which an area other than the area surrounding the competitor is masked in each of a plurality of image frames included in the original video data, in a case where the original video data is input, outputs a true value competition score that is an evaluation value for a competition of the competitor, in a case where the competitor mask video data is input, outputs an arbitrarily determined true value background score, and in a case where the background mask video data is input, outputs an arbitrarily determined true value competitor score is generated.

### TECHNICAL FIELD

The present invention relates to, for example, a learning device that learns know-how regarding a method of scoring a competition of a competitor, a learning model data generating method, a program corresponding to the learning device, and an estimation device, an estimating method, and a program corresponding to the estimation device that estimate a score of a competition based a learning result.

### BACKGROUND ART

In sports, there is a competition in which an official referee scores a score for a competition performed by a player such as high jump, figure skating, or gymnastics, and ranks individual competitions based on the scored score. There are quantitative scoring criteria in scoring such competitions.

In recent years, a technique used in activity quality evaluation in the field of computer vision, such as automatic estimation of a score in such a competition, has been studied, and a technique called Action Quality Assessment (AQA) is known as such a technique.

For example, in the technology described in Non Patent Literature 1, a method has been proposed in which video data in which a series of motions performed by a competitor is recorded is used as input data, and features are extracted from the video data by deep learning to estimate a score.

FIG. 8 is a block diagram illustrating a schematic configuration of a learning device 100 and an estimation device 200 in the technology described in Non Patent Literature 1. A learning unit 101 of the learning device 100 is provided with, as learning data, video data in which a series of motions performed by the competitor are recorded, and a true value score t_{score} scored by the referee for the competition of the competitor. The learning unit 101 includes a deep neural network (DNN), and applies coefficients such as weights and biases stored in a learning model data storage unit 102, that is, learning model data, to the DNN.

The learning unit 101 calculates the loss L_{SR} using the estimated score y_{score} obtained as the output value by providing the video data to the DNN and the true value score t_{score} corresponding to the video data. The learning unit 101 calculates a new coefficient to be applied to the DNN by the error back propagation method to reduce the calculated loss L_{SR}. The learning unit 101 updates the coefficient by writing the calculated new coefficient in the learning model data storage unit 102.

By repeating processing of updating these coefficients, the coefficients gradually converge, and the finally converged coefficients are stored in the learning model data storage unit 102 as learned learning model data. In Non Patent Literature 1, a loss function of L_{SR}=L1 distance (y_{score}, t_{score})+L2 distance (y_{score}, t_{score}) is used to calculate the loss L_{SR}.

An estimation device 200 includes an estimation unit 201 including a DNN having the same configuration as the learning unit 101, and a learning model data storage unit 202 that stores learned learning model data stored in the learning model data storage unit 102 of the learning device 100 in advance. The learned learning model data stored in the learning model data storage unit 202 is applied to the DNN of an estimation unit 201. The estimation unit 201 provides the DNN, as input data, video data recording a series of motions performed by an arbitrary competitor, thereby obtaining an estimated score y_{score} for the competition as an output value of the DNN.

### CITATION LIST

### Non Patent Literature

Non Patent Literature 1: Paritosh Parmar and Brendan Tran Morris, “Learning To Score Olympic Events”, In CVPR Workshop. 2017

### SUMMARY OF INVENTION

### Technical Problem

The following experiment was attempted on the technique described in Non Patent Literature 1. The video data (hereinafter, referred to as “original video data.”) in which a series of motions performed by a competitor illustrated in FIG. 9(a) are recorded and the video data (hereinafter, referred to as “competitor mask video data.”) in which an area where the competitor is displayed in each of the plurality of image frames included in the original video data illustrated in FIG. 9(b) is surrounded by rectangular areas 301, 302, and 303 and the rectangular area is filled with the average color of the image frames were prepared. Note that the range of the areas 301, 302, and 303 is indicated by a dotted frame, but this dotted frame is illustrated to clarify the range of the rectangular shape, and does not exist in the actual competitor mask video data.

As illustrated in FIG. 9(a), the accuracy degree of the estimated score y_{score} obtained in a case where the original video data is provided to the estimation unit 201 was “0.8890”. On the other hand, as illustrated in FIG. 9(b), the accuracy degree of the estimated score y_{score} obtained in a case where the competitor mask video data is provided to the estimation unit 201 was “0.8563”. From this experimental result, it can be seen that, in a case where the competitor mask video data is provided to the estimation unit 201, the score is estimated with high accuracy even though the motion of the competitor is not seen, and the estimation accuracy of the score is hardly lowered as compared with the case of the original video data in which the motion of the competitor is visible.

In the technique described in Non Patent Literature 1, only video data is provided as learning data without explicitly providing characteristics regarding the motion of the competitor, for example, joint coordinates. Therefore, from the above experimental results, the technology described in Non Patent Literature 1 extracts features in the video that are not related to the motion of the competitor, for example, features of the background of a venue or the like, and it is presumed that the learning model is not generalized to the motion of the competitor. Since features of the background of a venue or the like are extracted, it is also presumed that the technique described in Non Patent Literature 1 deteriorates accuracy with respect to video data including an unknown background.

Although there is a method of explicitly giving joint information such as human joint coordinates, estimation thereof is difficult because a joint operates in a complicated manner, and incorrect joint information adversely affects accuracy. Therefore, there is a circumstance that it is desired to avoid the technique of explicitly giving the joint information.

In view of the above circumstances, an object of the present invention is to provide a technique capable of generating learning model data generalized to the motion of a competitor from video data recording the motion of the competitor without explicitly providing joint information, and improving scoring accuracy in a competition.

### Solution to Problem

An aspect of the present invention is a learning device including a learning unit that generates learning model data in a learning model that inputs original video data in which a background and a motion of a competitor are recorded, competitor mask video data in which an area surrounding the competitor is masked in each of a plurality of image frames included in the original video data, and background mask video data in which an area other than the area surrounding the competitor is masked in each of a plurality of image frames included in the original video data, in a case where the original video data is input, outputs a true value competition score that is an evaluation value for a competition of the competitor, in a case where the competitor mask video data is input, outputs an arbitrarily determined true value background score, and in a case where the background mask video data is input, outputs an arbitrarily determined true value competitor score.

An aspect of the present invention is an estimation device including an input unit that captures video data to be evaluated in which a motion of a competitor is recorded, and an estimation unit that estimates an estimated competition score for the video data to be evaluated based on a learned learning model that inputs original video data in which a background and a motion of a competitor are recorded, competitor mask video data in which an area surrounding the competitor is masked in each of a plurality of image frames included in the original video data, and background mask video data in which an area other than the area surrounding the competitor is masked in each of a plurality of image frames included in the original video data, in a case where the original video data is input, outputs a true value competition score that is an evaluation value for a competition of the competitor, in a case where the competitor mask video data is input, outputs an arbitrarily determined true value background score, and in a case where the background mask video data is input, outputs an arbitrarily determined true value competitor score, and the video data to be evaluated captured by the input unit.

An aspect of the present invention is a learning model data generating method including generating learning model data in a learning model that inputs original video data in which a background and a motion of a competitor are recorded, competitor mask video data in which an area surrounding the competitor is masked in each of a plurality of image frames included in the original video data, and background mask video data in which an area other than the area surrounding the competitor is masked in each of a plurality of image frames included in the original video data, in a case where the original video data is input, outputs a true value competition score that is an evaluation value for a competition of the competitor, in a case where the competitor mask video data is input, outputs an arbitrarily determined true value background score, and in a case where the background mask video data is input, outputs an arbitrarily determined true value competitor score.

An aspect of the present invention is an estimating method including capturing video data to be evaluated in which a motion of a competitor is recorded, and estimating an estimated competition score for the video data to be evaluated based on a learned learning model that inputs original video data in which a background and a motion of a competitor are recorded, competitor mask video data in which an area surrounding the competitor is masked in each of a plurality of image frames included in the original video data, and background mask video data in which an area other than the area surrounding the competitor is masked in each of a plurality of image frames included in the original video data, in a case where the original video data is input, outputs a true value competition score that is an evaluation value for a competition of the competitor, in a case where the competitor mask video data is input, outputs an arbitrarily determined true value background score, and in a case where the background mask video data is input, outputs an arbitrarily determined true value competitor score, and the captured video data to be evaluated.

An aspect of the present invention is a program for causing a computer to operate as the learning device or the estimation device.

### Advantageous Effects of Invention

According to the present invention, it is possible to generate learning model data generalized to the motion of a competitor from video data recording the motion of the competitor without explicitly providing joint information, and improve scoring accuracy in a competition.

### BRIEF DESCRIPTION OF DRAWINGS

FIG. 1 is a block diagram illustrating a configuration of a learning device according to an embodiment of the present invention.

FIG. 2 is a diagram illustrating an example of an image frame included in original video data used in the present embodiment.

FIG. 3 is a diagram illustrating an example of an image frame included in competitor mask video data used in the present embodiment.

FIG. 4 is a diagram illustrating an example of an image frame included in background mask video data used in the present embodiment.

FIG. 5 is a diagram illustrating a flow of processing by the learning device according to the present embodiment.

FIG. 6 is a block diagram illustrating a configuration of an estimation device according to the present embodiment.

FIG. 7 is a diagram illustrating a flow of processing by the estimation device according to the present embodiment.

FIG. 8 is a block diagram illustrating configurations of a learning device and an estimation device in the technology described in Non Patent Literature 1.

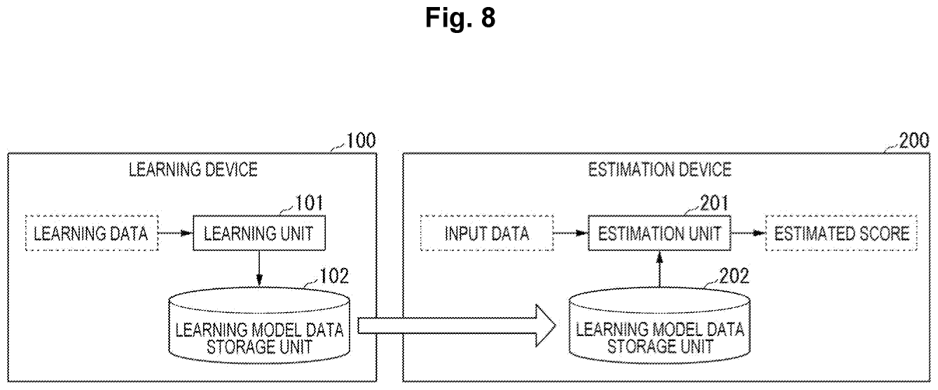

FIG. 9 is a diagram illustrating an outline of an experiment performed on the technology described in Non Patent Literature 1 and a result thereof.

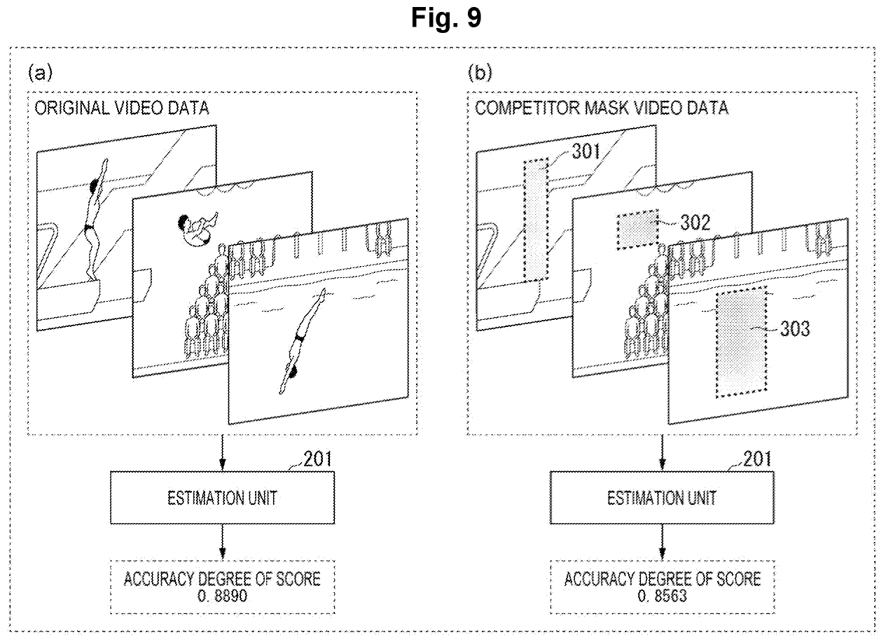

### DESCRIPTION OF EMBODIMENTS

### (Configuration of Learning Device)

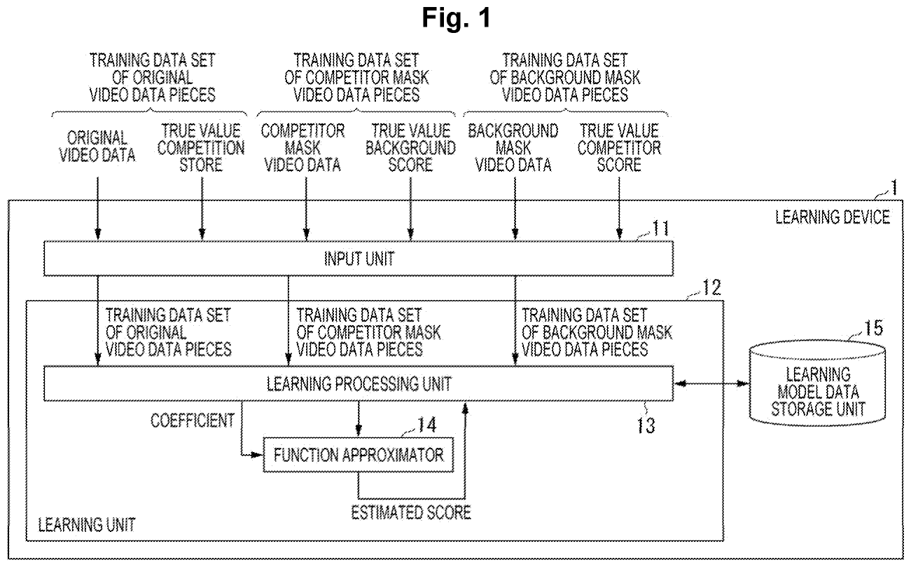

Hereinafter, an embodiment of the present invention will be described with reference to the drawings. FIG. 1 is a block diagram illustrating a configuration of a learning device 1 according to the embodiment of the present invention. The learning device 1 includes an input unit 11, a learning unit 12, and a learning model data storage unit 15.

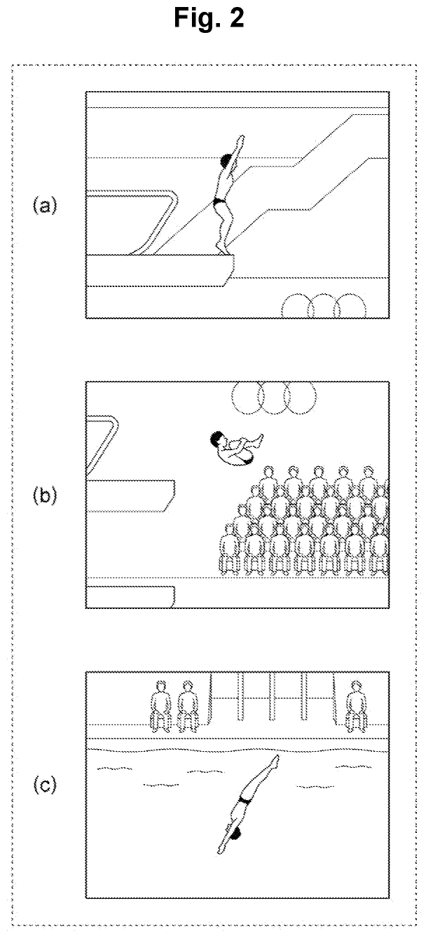

The input unit 11 captures original video data in which a series of motions to be scored as evaluation targets among the motions performed by the competitor are recorded together with the background. For example, in a case where the competitor is a high-diving swimmer, the original video data is recorded together with the background, and includes a motion until the player completes water entry into the pool after the player stands on the jumping platform, jumps, and performs a motion such as twisting or rotating. The image frames illustrated in FIGS. 2(a), 2(b), and 2(c) are examples of image frames arbitrarily selected in chronological order from a plurality of image frames included in certain original video data.

The input unit 11 captures a true value competition score which is an evaluation value for the motion of the competitor recorded in the original video data. The true value competition score is, for example, a score of a scoring result obtained by scoring the motion of the competitor recorded in the original video data based on a quantitative scoring criterion actually employed in the competition by the referee when the original video data is recorded. The input unit 11 sets the captured original video data and the true value competition score corresponding to the original video data in association with each other as a training data set of the original video data.

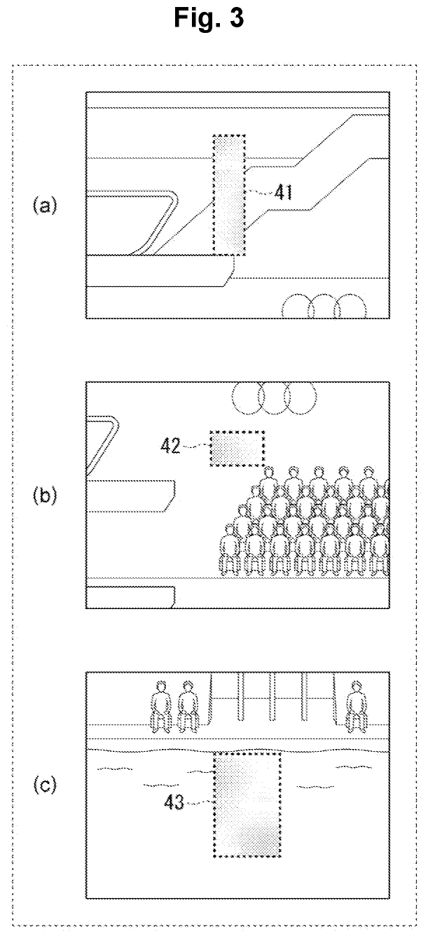

The input unit 11 captures the competitor mask video data corresponding to the original video data. Here, the competitor mask video data is video data in which a rectangular area surrounding an area of the competitor is masked in each of a plurality of image frames included in the original video data. The image frames illustrated in FIGS. 3(a), 3(b), and 3(c) are image frames of the competitor mask video data corresponding to the image frames of the original video data illustrated in FIGS. 2(a), 2(b), and 2(c), respectively. Note that, in FIGS. 3(a), 3(b), and 3(c), the ranges of the rectangular areas 41, 42, and 43 are indicated by dotted frames, but the dotted frames are illustrated to clarify the ranges of the rectangular areas 41, 42, and 43, and do not exist in the actual competitor mask video data. In FIGS. 3(a), 3(b), and 3(c), a state in which the rectangular areas 41, 42, and 43 are masked is indicated by hatching, but actually, each of the rectangular areas 41, 42, and 43 is filled with, for example, the average color of the image frame including each of the rectangular areas 41, 42, and 43 and is masked.

The input unit 11 captures a true value background score corresponding to the competitor mask video data. The true value background score is an evaluation value for the competitor mask video data. The competitor mask video data is video data that the competitor cannot be seen completely. Therefore, in consideration of the fact that the referee cannot score, a score that is not evaluated in the competition, for example, the lowest score in the competition is determined as the true value background score. For example, in a case where the score in a case where evaluation is not performed in the competition is “0”, a value of “0” is determined in advance as the true value background score. The input unit 11 sets a training data set of the competitor mask video data by associating the captured competitor mask video data with the true value background score corresponding to the competitor mask video data.

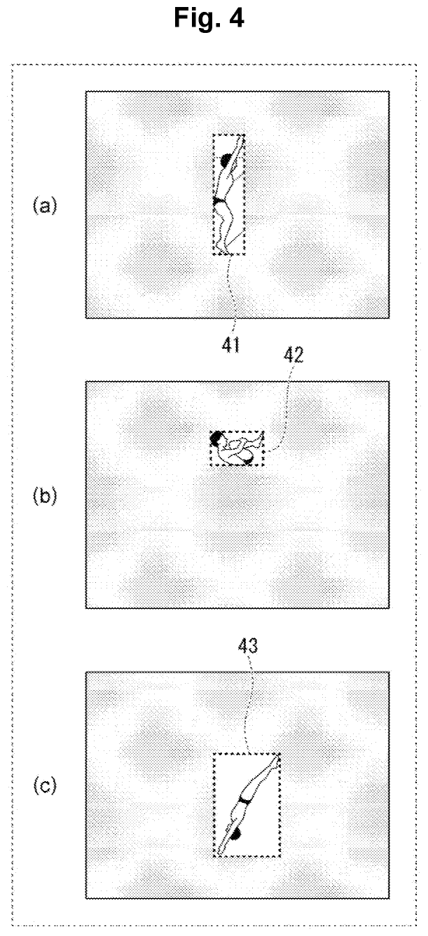

The input unit 11 captures the background mask video data corresponding to the original video data. Here, the background mask video data is video data in which an area other than a rectangular area surrounding the area of the competitor is masked in each of the plurality of image frames included in the original video data. The image frames illustrated in FIGS. 4(a), 4(b), and 4(c) are image frames of the background mask video data corresponding to the image frames of the original video data illustrated in FIGS. 2(a), 2(b), and 2(c). Note that, in FIGS. 4(a), 4(b), and 4(c), the ranges of the rectangular areas 41, 42, and 43 are indicated by dotted frames, but the dotted frames are illustrated to clarify the ranges of the rectangular areas 41, 42, and 43, and do not exist in the actual background mask video data. In FIGS. 4(a), 4(b), and 4(c), a state in which the areas other than the rectangular areas 41, 42, and 43 are masked is indicated by hatching, but actually, the areas other than the rectangular areas 41, 42, and 43 are filled with, for example, the average color of the image frame including each of the rectangular areas 41, 42, and 43 and masked.

The input unit 11 captures a true value competitor score corresponding to the background mask video data. The true value competitor score is an evaluation value for the background mask video data. The background mask video data is video data in which the competitor is visible. Therefore, for example, the true value competition score of the original video data corresponding to the background mask video data is determined in advance as the true value competitor score corresponding to the background mask video data. The input unit 11 sets a training data set of the background mask video data by associating the captured background mask video data with the true value competitor score captured in correspondence with the background mask video data.

In a case where the training data sets of the plurality of pieces of original video data are captured, the input unit 11 captures the training data set of the competitor mask video data and the training data set of the background mask video data corresponding to each of the training data sets of the plurality of pieces of original video data.

The ranges of the rectangular areas 41, 42, and 43 illustrated in FIGS. 3(a), 3(b), and 3(c) and FIGS. 4(a), 4(b), and 4(c) may be automatically detected from each of the image frames included in the video data by, for example, a technique illustrated in the following reference literature, or the ranges of the rectangular areas 41, 42, and 43 may be manually determined while visually confirming all the image frames included in the video data.

### [Reference Literature: Kaiming He, Georgia Gkioxari, Piotr Dollar and Ross Girshick, “Mask R-CNN”, In ICCV, 2017]

In a case where the technology described in the above reference literature is adopted, for example, the input unit 11 may capture the original video data, detect a range of a rectangular area from the captured original video data, and generate the competitor mask video data and the background mask video data from the original video data based on the detected range of the rectangular area. In this case, it is assumed that, for example, it is defined that “0” described above is applied as the true value background score, and it is defined that the true value competition score is applied as the true value competitor score. In this case, the input unit 11 can generate the training data set of the original video data, the training data set of the competitor mask video data, and the training data set of the background mask video data by capturing only the original video data and the true value competition score.

Note that each of the true value competition score, the true value background score, and the true value competitor score is not limited to the evaluation value as described above, and may be arbitrarily determined. For example, the score of the scoring result obtained by scoring the competition of the competitor recorded in the original video data by a criterion other than the quantitative scoring criterion adopted in the competition may be set as the true value competition score. As the true value competitor score, a value other than the true value competition score may be adopted. The true value background score and the true value competitor score may be changed in the middle of processing.

The learning unit 12 includes a learning processing unit 13 and a function approximator 14. For example, DNN is applied as the function approximator 14. Note that the DNN may have any network structure. The function approximator 14 is provided a coefficient stored in the learning model data storage unit 15 by the learning processing unit 13. Here, in a case where the function approximator 14 is the DNN, the coefficient is a weight or a bias applied to each of a plurality of neurons included in the DNN.

By providing the original video data included in the training data set of the original video data to the function approximator 14, the learning processing unit 13 performs learning processing of updating the coefficient so that the estimated competition score obtained as the output value of the function approximator 14 approaches the true value competition score corresponding to the original video data provided to the function approximator 14. By providing the competitor mask video data included in the training data set of the competitor mask video data to the function approximator 14, the learning processing unit 13 performs learning processing of updating the coefficient so that the estimated background score obtained as the output value of the function approximator 14 approaches the true value background score corresponding to the competitor mask video data provided to the function approximator 14. By providing the background mask video data included in the training data set of the background mask video data to the function approximator 14, the learning processing unit 13 performs learning processing of updating the coefficient so that the estimated competitor score obtained as the output value of the function approximator 14 approaches the true value competitor score corresponding to the background mask video data provided to the function approximator 14.

The learning model data storage unit 15 stores coefficients to be applied to the function approximator 14, that is, learning model data. The learning model data storage unit 15 stores the initial value of the coefficient in advance in the initial state. The coefficient stored in the learning model data storage unit 15 is rewritten to a new coefficient by the learning processing unit 13 every time the learning processing unit 13 calculates a new coefficient by learning processing.

That is, by the learning processing performed by the learning processing unit 13, the learning unit 12 generates the learning model data in the learning model in which the original video data, the competitor mask video data, and the background mask video data are input, the true value competition score is output in a case where the original video data is input, the true value background score is output in a case where the competitor mask video data is input, and the true value competitor score is output in a case where the background mask video data is input. Here, the learning model is a coefficient stored in the learning model data storage unit 15, that is, the function approximator 14 to which the learning model data is applied.

### (Processing by Learning Device)

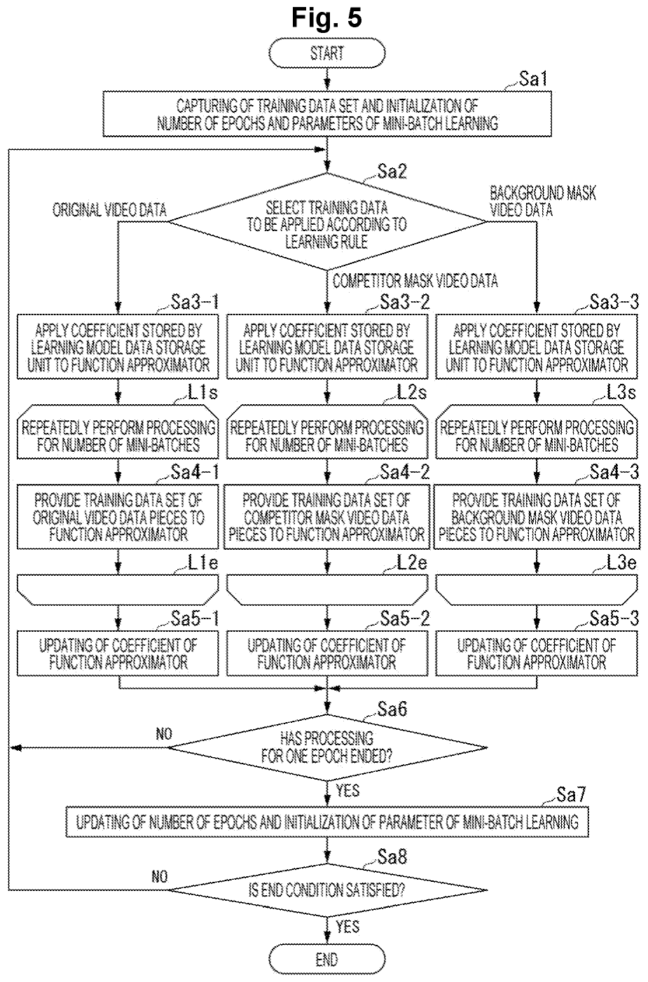

Next, processing by the learning device 1 will be described with reference to FIG. 5. FIG. 5 is a flowchart illustrating a flow of processing by the learning device 1. A learning rule is predetermined in the learning processing unit 13 included in the learning device 1, and processing for each predetermined learning rule will be described below.

### (Learning Rule (Part 1))

For example, it is assumed that the following learning rule is determined in advance in the learning processing unit 13. That is, it is assumed that a learning rule in which the number of each of the training data set of the original video data, the training data set of the competitor mask video data, and the training data set of the background mask video data is, for example, N, the mini-batch size is M, and all of the training data set of the original video data, the training data set of the competitor mask video data, and the training data set of the background mask video data are used as processing for one epoch is determined in advance. In the learning rule, it is assumed that it is predetermined that the processing is performed in the order of the training data set of the original video data, the training data set of the competitor mask video data, and the training data set of the background mask video data. Here, N and M are integers of 1 or more, and may be any value as long as M<N. Hereinafter, as an example, a case where N is “300” and M is “10” will be described.

The input unit 11 of the learning device 1 captures the 300 pieces of original video data and the true value competition scores respectively corresponding to the 300 pieces of original video data, associates the 300 pieces of captured original video data with the true value competition scores respectively corresponding to the captured original video data pieces, and generates training data sets of the 300 pieces of original video data.

The input unit 11 captures the 300 pieces of competitor mask video data corresponding to each of the 300 pieces of original video data and the true value background score corresponding to each of the competitor mask video data pieces, and generates a training data set of the 300 pieces of competitor mask video data by associating the 300 pieces of captured competitor mask video data with the true value background score corresponding to each of the captured competitor mask video data pieces.

The input unit 11 captures the 300 pieces of background mask video data corresponding to each of the 300 pieces of original video data and the true value competitor score corresponding to each of the background mask video data pieces, and generates a training data set of the 300 pieces of background mask video data by associating the 300 pieces of the captured background mask video data with the true value competitor score corresponding to each of the captured background mask video data pieces.

The input unit 11 outputs the training data sets of the 300 pieces of original video data, the training data sets of the 300 pieces of competitor mask video data, and the training data sets of the 300 pieces of background mask video data to the learning processing unit 13. The learning processing unit 13 captures the training data sets of the 300 pieces of original video data, the training data sets of the 300 pieces of competitor mask video data, and the training data sets of the 300 pieces of background mask video data output from the input unit 11. The learning processing unit 13 writes and stores the captured training data sets of the 300 pieces of original video data, the captured training data set of the 300 pieces of competitor mask video data, and the captured training data set of the 300 pieces of background mask video data in the internal storage area.

The learning processing unit 13 provides an area for storing the number of epochs, that is, the value of the number of times of epochs in an internal storage area, and initializes the number of epochs to “0”. The learning processing unit 13 provides an area for storing the parameters of the mini-batch learning, that is, the number of times of processing indicating the number of times of providing each of the original video data, the competitor mask video data, and the background mask video data to the function approximator 14, in the internal storage area, and initializes the number of times of processing of each of the original video data, the competitor mask video data, and the background mask video data to “0” (step Sa1).

The learning processing unit 13 selects a training data set to be selected according to the number of times of processing of each of the original video data, the competitor mask video data, and the background mask video data stored in the internal storage area and a predetermined learning rule (step Sa2). Here, the number of times of processing of each of the original video data, the competitor mask video data, and the background mask video data is “0”, and all of the 300 pieces of original video data, the 300 pieces of competitor mask video data, and the 300 pieces of background mask video data are not used for processing. As described above, in the learning rule, it is predetermined that the processing is performed in the order of the training data set of the original video data, the training data set of the competitor mask video data, and the training data set of the background mask video data. Therefore, the learning processing unit 13 first selects a training data set of the original video data (Step Sa2, Original video data).

The learning processing unit 13 reads out the coefficient stored in the learning model data storage unit 15 and applies the read coefficient to the function approximator 14 (step Sa3-1). The learning processing unit 13 reads out the training data sets of the original video data of the number of learning mini-batch sizes M defined in the learning rule from the internal storage area in order from the head for the training data set of the original video data selected in the processing of step Sa2.

Here, since the mini-batch size M is “10”, the learning processing unit 13 reads out the training data set of the 10 pieces of original video data from the internal storage area. The learning processing unit 13 selects one piece of original video data from the read training data set of the 10 pieces of original video data and provides the selected original video data to the function approximator 14. The learning processing unit 13 captures the estimated competition score output by the function approximator 14 by providing the original video data. The learning processing unit 13 writes and stores the captured estimated competition score and the true value competition score corresponding to the original video data provided to the function approximator 14 in an internal storage area in association with each other. Every time the original video data is provided to the function approximator 14, the learning processing unit 13 adds 1 to the number of times of processing of the original video data stored in the internal storage area (Step Sa4-1).

The learning processing unit 13 repeatedly performs the processing of step Sa4-1 on each of the 10 pieces of original video data included in the training data set of the 10 pieces of original video data (loops L1s to L1e), and generates 10 combinations of the estimated competition score and the true value competition score in an internal storage area.

The learning processing unit 13 calculates a loss based on a predetermined loss function based on the 10 combinations of the estimated competition score and the true value competition score stored in an internal storage area. Based on the calculated loss, the learning processing unit 13 calculates a new coefficient to be applied to the function approximator 14 by, for example, the error back propagation method. The learning processing unit 13 rewrites and updates the coefficient stored in the learning model data storage unit 15 with the calculated new coefficient (step Sa5-1).

The learning processing unit 13 refers to the number of times of processing of each of the original video data, the competitor mask video data, and the background mask video data stored in the internal storage area, and determines whether the processing for one epoch has ended (step Sa6). As described above, in the learning rule, it is defined that all the training data set of the original video data pieces, the training data set of the competitor mask video data pieces, and the training data set of the background mask video data pieces are used as processing of one epoch. Therefore, the state in which the processing for one epoch is completed is a state in which the number of times of processing of each of the original video data, the competitor mask video data, and the background mask video data is “300” or more. Here, the number of times of processing of the original video data is “10”, and the number of times of processing of each of the competitor mask video data and the background mask video data is “0”. Therefore, the learning processing unit 13 determines that the processing for one epoch has not ended (Step Sa6, No), and advances the processing to step Sa2.

In a case where the number of times of processing of the original video data is not “300” or more in the processing of step Sa2 to be performed again, the learning processing unit 13 selects the training data set of the original video data again in the processing of step Sa2 (Step Sa2, Original video data), and performs the processing of step Sa3-1 and subsequent steps.

On the other hand, in a case where the number of times of processing of the original video data is “300” or more in the processing of step Sa2 performed again, the learning processing unit 13 then selects the training data set of the competitor mask video data according to the learning rule (Step Sa2, Competitor mask video data).

The learning processing unit 13 reads out the coefficient stored in the learning model data storage unit 15 and applies the read coefficient to the function approximator 14 (step Sa3-2).

The learning processing unit 13 reads out the training data sets of the 10 pieces of competitor mask video data sequentially from the top from the internal storage area for the training data set of the competitor mask video data selected in the processing of step Sa2. The learning processing unit 13 selects one piece of competitor mask video data from the read training data sets of the 10 pieces of original video data and provides the selected original video data to the function approximator 14. The learning processing unit 13 captures the estimated background score output by the function approximator 14 by providing the competitor mask video data. The learning processing unit 13 writes and stores the captured estimated background score and the true value background score corresponding to the competitor mask video data provided to the function approximator 14 in an internal storage area in association with each other. Every time the competitor mask video data is provided to the function approximator 14, the learning processing unit 13 adds 1 to the number of times of processing of the competitor mask video data stored in the internal storage area (Step Sa4-2).

The learning processing unit 13 repeatedly performs the processing of step Sa4-2 on each of the 10 pieces of competitor mask video data included in the training data set of the 10 pieces of competitor mask video data (loops L2s to L2e), and generates 10 combinations of the estimated background score and the true value background score in an internal storage area.

The learning processing unit 13 calculates a loss based on a predetermined loss function using the 10 combinations of the estimated background score and the true value background score stored in the internal storage area. Based on the calculated loss, the learning processing unit 13 calculates a new coefficient to be applied to the function approximator 14 by, for example, the error back propagation method. The learning processing unit 13 rewrites and updates the coefficient stored in the learning model data storage unit 15 with the calculated new coefficient (step Sa5-2).

The learning processing unit 13 determines whether the processing for one epoch has been completed (step Sa6). In a case where the number of times of processing of the competitor mask video data is not “300” or more, the learning processing unit 13 determines that the processing for one epoch has not been ended (Step Sa6, No), and advances the processing to step Sa2.

In a case where the number of times of processing of the competitor mask video data is not “300” or more in the processing of step Sa2 to be performed again, the learning processing unit 13 again selects the training data set of the competitor mask video data (Step Sa2, Competitor mask video data). Thereafter, the learning processing unit 13 performs the processing of step Sa3-2 and subsequent steps.

On the other hand, in a case where the number of times of processing of the competitor mask video data is “300” or more in the processing of step Sa2 performed again, the learning processing unit 13 then selects the training data set of the background mask video data according to the learning rule (Step Sa2, Background mask video data).

The learning processing unit 13 reads out the coefficient stored in the learning model data storage unit 15. The learning processing unit 13 applies the read coefficient to the function approximator 14 (step Sa3-3).

The learning processing unit 13 reads out the training data sets of the 10 pieces of background mask video data sequentially from the top from the internal storage area for the training data set of the background mask video data selected in the processing of step Sa2. The learning processing unit 13 selects one piece of background mask video data from the read training data set of the 10 pieces of background mask video data and provides the selected background mask video data to the function approximator 14. The learning processing unit 13 captures the estimated competitor score output by the function approximator 14 by providing the background mask video data. The learning processing unit 13 writes and stores the captured estimated competitor score and the true value competitor score corresponding to the background mask video data provided to the function approximator 14 in the internal storage area in association with each other. Every time the background mask video data is provided to the function approximator 14, the learning processing unit 13 adds 1 to the number of times of processing of the background mask video data stored in the internal storage area (Step Sa4-3).

The learning processing unit 13 repeatedly performs the processing of step Sa4-3 on each of the 10 pieces of background mask video data included in the training data set of the 10 pieces of background mask video data (loops L3s to L3e), and generates 10 combinations of the estimated competitor score and the true value competitor score in an internal storage area.

The learning processing unit 13 calculates a loss based on a predetermined loss function based on the 10 combinations of the estimated competitor score and the true value competitor score stored in an internal storage area. Based on the calculated loss, the learning processing unit 13 calculates a new coefficient to be applied to the function approximator 14 by, for example, the error back propagation method. The learning processing unit 13 rewrites and updates the coefficient stored in the learning model data storage unit 15 with the calculated new coefficient (step Sa5-3).

The learning processing unit 13 determines whether the processing for one epoch has been completed (step Sa6). In a case where the number of times of processing of the background mask video data is not “300” or more, the learning processing unit 13 determines that the processing for one epoch has not been ended (Step Sa6, No). In this case, the learning processing unit 13 advances the processing to step Sa2.

In a case where the number of times of processing of the background mask video data is not “300” or more in the processing of step Sa2 to be performed again, the learning processing unit 13 selects the training data set of the background mask video data again in the processing of step Sa2 (Step Sa2, Background mask video data). Thereafter, the learning processing unit 13 performs the processing of step Sa3-3 and subsequent steps.

On the other hand, in the processing of step Sa6, in a case where the processing for one epoch has been completed, that is, the number of times of processing of each of the original video data, the competitor mask video data, and the background mask video data is “300” or more, the learning processing unit 13 determines that the processing for one epoch has been completed (Step Sa6, Yes). The learning processing unit 13 adds 1 to the number of epochs stored in the internal storage area. The learning processing unit 13 initializes the parameter of the mini-batch learning stored in the internal storage area to “0” (step Sa7). That is, the learning processing unit 13 initializes the number of times of processing of each of the original video data, the competitor mask video data, and the background mask video data to “0”.

The learning processing unit 13 determines whether or not the number of epochs stored in the internal storage area satisfies the end condition (step Sa8). For example, in a case where the number of epochs reaches a predetermined upper limit value, the learning processing unit 13 determines that the end condition is satisfied. On the other hand, for example, in a case where the number of epochs has not reached a predetermined upper limit value, the learning processing unit 13 determines that the end condition is not satisfied.

In a case where it is determined that the number of epochs satisfies the end condition (Step Sa8, Yes), the learning processing unit 13 ends the processing. On the other hand, in a case where the learning processing unit 13 determines that the number of epochs does not satisfy the end condition (Step Sa8, No), the processing proceeds to the processing of step Sa2. In the processing of step Sa2 performed again after the processing of step Sa8, the learning processing unit 13 selects the training data set of the original video data pieces, the training data set of the competitor mask video data pieces, and the background mask video data set in this order according to the learning rule again. Thereafter, the learning processing unit 13 performs the processing of step Sa3-1 and subsequent steps, the processing of step Sa3-2 and subsequent steps, and the processing of step Sa3-3 and subsequent steps on each selected component.

As a result, when the learning processing unit 13 ends the processing, the learned coefficient, that is, the learned learning model data, is generated in the learning model data storage unit 15. Note that the learning processing performed by the learning processing unit 13 is processing of updating the coefficient to be applied to the function approximator 14 by the repetitive processing illustrated in steps Sa2 to Sa8 in FIG. 5.

Note that, in the processing of FIG. 5 described above, when reading out the next 10 training data sets from the internal storage area in each processing of steps Sa4-1, Sa4-2, and Sa4-3 performed the second and subsequent times, the learning processing unit 13 is assumed to read 10 training data sets subsequent to the 10 training data sets selected in the processing of the same step of the previous time.

In the processing of FIG. 5 described above, the loss function used by the learning processing unit 13 in the processing of steps Sa5-1, Sa5-2, and Sa5-3 may be, for example, a function for calculating the L1 distance, a function for calculating the L2 distance, or a function for calculating the sum of the L1 distance and the L2 distance.

### (Learning Rule (Part 2))

As a learning rule, for example, the upper limit value of the number of epochs is predetermined to “100”, and in order to stabilize the learning processing, that is, to moderate the convergence of the coefficients, until the number of epochs reaches “50”, the learning processing unit 13 selects the training data set of the original video data pieces and the training data set of the competitor mask video data pieces in this order and does not select the background mask video data in the processing of step Sa2. After the number of epochs reaches “50”, for the next 50 epochs, the learning processing unit 13 may set a learning rule to select the training data set of the original video data pieces, the training data set of the competitor mask video data pieces, and the training data set of the background mask video data pieces in this order in the processing of step Sa2. As a result, in the processing of FIG. 5, the processing of steps Sa3-3 to Sa5-3 is not performed until the number of epochs reaches “50”, and after the number of epochs reaches “50”, the processing of FIG. 5 is performed for the next 50 epochs. In this manner, a learning rule of changing the training data set selected in the processing of step Sa2 according to the number of epochs may be defined.

Note that the number of epochs being “50” is an example, and another value may be determined. Instead of limiting the number of epochs for changing the combination of the training data sets to be selected to one, a plurality of numbers of epochs for changing the combination of the training data sets to be selected may be determined, and the learning processing unit 13 may determine a learning rule for changing the training data set to be selected every time the number of epochs reaches the plurality of determined numbers of epochs. In this case, the combination of the training data selected by the learning processing unit 13 in the processing of step Sa2 is not limited to the example of the combination of the training data pieces described above, and may be any combination. The learning rule may be such that the training data set selected by the learning processing unit 13 in the processing of step Sa2 is randomly changed every time the number of epochs increases.

### (Learning Rule (Part 3))

For example, in a case where the true value background score is set to “0”, even after the learning processing is performed to a certain extent, it is known as a result of simulation that the estimated background score output by the function approximator 14 does not completely become “0” but outputs “1” or “2” when the competitor mask video data is provided to the function approximator 14. It can be considered that this may be due to the fact that the referee may be in a state of slightly scoring against the background. In a case where the true value competitor score is set as the true value competition score, it is known that the function approximator 14 does not output a value that completely matches the true value competition score when the background mask video data is provided to the function approximator 14 even after the learning processing is performed to a certain extent.

In this way, it is assumed that the background affects the scoring of the referee, and as a learning rule, when the number of epochs becomes a predetermined number less than a predetermined upper limit value, the learning processing unit 13 may set a learning rule in which all the true value background scores included in the training data set of the competitor mask video data are replaced with the estimated background scores output by the function approximator 14 when the competitor mask video data is given at that time, and all the true value competitor scores included in the training data set of the background mask video data are replaced with the estimated competitor scores output by the function approximator 14 when the background mask video data is given at that time.

In a case where this learning rule is applied, the learning processing unit 13 performs the processing of FIG. 5 described above until the number of epochs reaches the predetermined number described above, and when the number of epochs reaches the predetermined number, the processing of step Sa2 and subsequent steps is performed for the remaining number of epochs based on the training data set of the original video data, the training data set of the competitor mask video data for which the replacement of the true value background score has been performed in accordance with the learning rule, and the training data set of the background mask video data for which the replacement of the true value competitor score has been performed in accordance with the learning rule. Note that the learning processing unit 13 may perform replacement according to the learning rule and then perform the processing again from the beginning. That is, the learning processing unit 13 may initialize the number of epochs to “0”, initialize the parameters of the mini-batch learning, and perform the processing of step Sa2 and subsequent steps. Note that, in a case where the processing is performed again from the beginning, the coefficients stored in the learning model data storage unit 15 may be continuously used as they are, or the coefficients stored in the learning model data storage unit 15 may be initialized.

In the above description, when the number of epochs reaches a predetermined number, the true value background score and the true value competitor score are replaced. However, the true value background score and the true value competitor score may be replaced at any timing during predetermined learning processing other than the timing when the number of epochs reaches the predetermined number. For example, it may be a timing at which the learning processing unit 13 detects that the difference between the estimated background score output by the function approximator 14 and the immediately preceding estimated background score has continuously become equal to or less than a certain value at a predetermined number of times, and the difference between the estimated competitor score output by the function approximator 14 and the immediately preceding estimated competitor score has continuously become equal to or less than a certain value at a predetermined number of times.

### (Other Learning Rules)

In the processing of FIG. 5 described above, learning processing by mini-batch learning in which the mini-batch size M is set to a value smaller than N, which is the number of training data sets of each of the original video data, the competitor mask video data, and the background mask video data, is illustrated. On the other hand, learning processing by batch learning with the mini-batch size M=N may be performed, or learning processing by online learning with the mini-batch size M=1 may be performed.

In the processing of FIG. 5 described above, when selecting the data of the number of mini-batch sizes M from each of the original video data, the competitor mask video data, and the background mask video data stored in the internal storage area in the processing of steps Sa4-1, 4a-2, and 4a-3 repeatedly performed, the learning processing unit 13 selects each number of mini-batch sizes M in the order of storage in the internal storage area. On the other hand, the learning processing unit 13 may randomly select the training data of the number of mini-batch sizes M from the internal storage area. For example, until the number of epochs reaches a predetermined number less than a predetermined upper limit value, the training data may be selected by the number of mini-batch sizes M in the order of storage in the internal storage area. After the number of epochs reaches a predetermined number less than a predetermined upper limit value, the training data of the number of mini-batch sizes M may be randomly selected.

In the processing of FIG. 5 described above, in the processing of step Sa5-1, the loss is calculated based on the combination of the estimated competition score and the true value competition score, in the processing of step Sa5-2, the loss is calculated based on the combination of the estimated background score and the true value background score, and in the processing of step Sa5-3, the loss is calculated based on the combination of the estimated competitor score and the true value competitor score, and a new coefficient is calculated based on each loss.

On the other hand, for example, the learning processing unit 13 advances the processing to step Sa6 without performing step Sa5-1 after the processing of the loops L1s to L1e ends in the processing of FIG. 5 described above. Thereafter, even after the processing of the loops L2s to L2e ends, the learning processing unit 13 advances the processing to step Sa6 without performing the processing of step Sa5-2. Thereafter, after the processing of the loops L3s to L3e ends, the learning processing unit 13 may calculate a loss based on all combinations of the estimated competition score and the true value competition score, all combinations of the estimated background score and the true value background score, and all combinations of the estimated competitor score and the true value competitor score generated in the internal storage area, and calculate a new coefficient based on the calculated loss, in the processing of step Sa5-3.

For example, the learning processing unit 13 advances the processing to step Sa6 without performing step Sa5-1 after the processing of the loops L1s to L1e ends in the processing of FIG. 5 described above. Thereafter, after the processing of the loops L2s to L2e ends, the learning processing unit 13 may calculate a loss based on all combinations of the estimated competition score and the true value competition score, and all combinations of the estimated background score and the true value background score generated in the internal storage area, and calculate a new coefficient based on the calculated loss, in the processing of step Sa5-2.

For example, the learning processing unit 13 advances the processing to step Sa6 without performing step Sa5-2 after the processing of the loops L2s to L2e ends in the processing of FIG. 5 described above. Thereafter, after the processing of the loops L3s to L3e ends, the learning processing unit 13 may calculate a loss based on all combinations of the estimated background score and the true value background score, and all combinations of the estimated competitor score and the true value competitor score generated in the internal storage area, and calculate a new coefficient based on the calculated loss, in the processing of step Sa5-3.

In the processing of FIG. 5 described above, in the processing of step Sa2, the learning processing unit 13 selects the training data set of the original video data pieces, the training data set of the competitor mask video data pieces, and the training data set of the background mask video data pieces in this order. However the selection order is not limited to this order, and may be arbitrarily changed. In this case, for example, when selecting the training data set of the original video data pieces, the training data set of the competitor mask video data pieces, and the training data set of the background mask video data pieces in this order, the learning processing unit 13 advances the processing to step Sa6 without performing step Sa5-1, for example, after the processing of the loops L1s to L1e ends. Thereafter, after the processing of the loops L3s to L3e ends, the learning processing unit 13 may calculate a loss based on all combinations of the estimated competition score and the true value competition score, and all combinations of the estimated competitor score and the true value competitor score generated in the internal storage area, and calculate a new coefficient based on the calculated loss, in the processing of step Sa5-3.

In this manner, the selection order of the training data set of the original video data pieces, the training data set of the competitor mask video data pieces, and the training data set of the background mask video data pieces in the processing of step Sa2 may be arbitrarily determined. The learning processing unit 13 may calculate a loss by arbitrarily selecting the combination of the estimated competition score and the true value competition score, the combination of the estimated background score and the true value background score, and the combination of the estimated competitor score and the true value competitor score, and calculate a new coefficient based on the calculated loss.

In the processing of FIG. 5 described above, for example, in a case where the training data set of the original video data is selected, the learning processing unit 13 repeatedly selects the training data set of the original video data in the processing of step Sa2 performed again until the number of times of processing of the original video data becomes N or more. However, the learning processing unit 13 may select another training data set different from the training data set selected in the previous step Sa2.

A learning rule in which each of the other learning rules described above, the learning rule (part 1), the learning rule (part 2), and the learning rule (part 3) are arbitrarily combined may be determined in advance.

### (Configuration of Estimation Device)

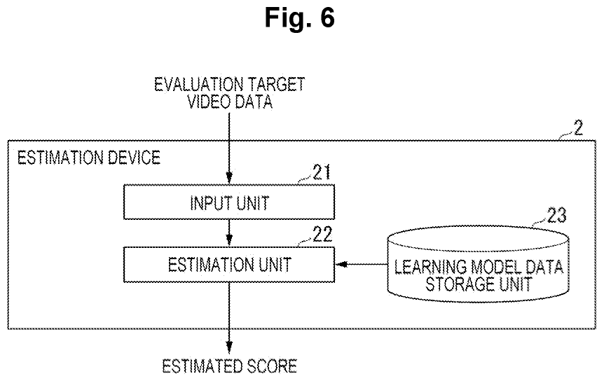

FIG. 6 is a block diagram illustrating a configuration of an estimation device 2 according to an embodiment of the present invention. The estimation device 2 includes an input unit 21, an estimation unit 22, and a learning model data storage unit 23. The learning model data storage unit 23 stores in advance a learned coefficient stored in the learning model data storage unit 15 when the learning device 1 ends the processing illustrated in FIG. 5, that is, learned learning model data. The input unit 21 captures arbitrary video data, that is, video data to be evaluated (hereinafter, referred to as evaluation target video data) in which a series of motions performed by an arbitrary competitor is recorded together with a background.

The estimation unit 22 internally includes a function approximator having the same configuration as the function approximator 14 included in the learning processing unit 13. The estimation unit 22 calculates an estimated score corresponding to the video data based on the evaluation target video data fetched by the input unit 21 and the function approximator to which the learned coefficient stored in the learning model data storage unit 23 is applied, that is, the learned learning model.

### (Estimation Processing by Estimation Device)

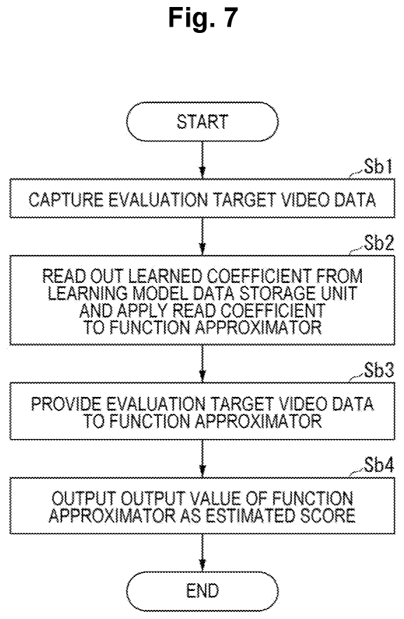

FIG. 7 is a flowchart illustrating a flow of processing by the estimation device 2. The input unit 21 captures the evaluation target video data, and outputs the captured evaluation target video data to the estimation unit 22 (step Sb1). The estimation unit 22 captures the evaluation target video data output from input unit 21. The estimation unit 22 reads out the learned coefficient from the learning model data storage unit 23. The estimation unit 22 applies the read learned coefficient to a function approximator internally provided (step Sb2).

The estimation unit 22 gives the captured evaluation target video data to the function approximator (step Sb3). The estimation unit 22 outputs the output value of the function approximator as the estimated score for the evaluation target video data (step Sb4).

The learning device 1 of the present embodiment described above generates the learning model data in the learning model in which the original video data, the competitor mask video data, and the background mask video data are input, the true value competition score is output in a case where the original video data is input, the true value background score is output in a case where the competitor mask video data is input, and the true value competitor score is output in a case where the background mask video data is input. The learning device 1 performs learning processing using the original video data, the competitor mask video data, and the background mask video data, thereby being promoted to extract features related to the motion of the competitor from the video data. As a result, the learning device 1 can generate learning model data generalized to the motion of the competitor from the video data recording the motion of the competitor without explicitly giving the joint information. In the estimation processing performed by the estimation device 2 using the learned learning model generated by applying the learned learning model data generated by the learning device 1 in this manner to the function approximator, it is possible to improve the scoring accuracy in the competition.

Note that the above embodiment illustrates an example in which one competitor is included in the original video data, but the competition recorded in the original video data may be a competition performed by a plurality of competitors, and the rectangular area in this case is an area surrounding the plurality of competitors.

In the above embodiment, the shape surrounding the area of the competitor is rectangular, but the shape is not limited to the rectangular shape, and may be a shape other than the rectangular shape.

In the above embodiment, in the video data of the competitor mask video data and the background mask video data, the color at the time of masking is set as the average color in the image frame in which masking is performed. On the other hand, the average color of all the image frames included in the original video data corresponding to each of the video data of the competitor mask video data and the background mask video data may be selected as the color for masking. For each piece of video data, a color for masking an arbitrarily determined color may be used. Note that, since it is better to make the color at the time of masking inconspicuous, it is necessary to select an inconspicuous color according to the overall hue for each image frame, and in that respect, it is considered that it is most effective to select an average color for each image frame that harmonized with the background and becomes an inconspicuous hue as the color at the time of masking.

The function approximator 14 included in the learning unit 12 of the learning device 1 and the function approximator included in the estimation unit 22 of the estimation device 2 according to the above-described embodiment are DNN, for example. However, a neural network other than DNN, a means based on machine learning, or an arbitrary means for calculating a coefficient of a function approximated in the function approximator may be applied thereto.

The learning device 1 and the estimation device 2 may be integrated. In such a configuration, a device in which the learning device 1 and the estimation device 2 are integrated has a learning mode and an estimation mode. The learning mode is a mode in which learning processing is performed by the learning device 1 to generate learning model data. That is, in the learning mode, the device in which the learning device 1 and the estimation device 2 are integrated executes the processing illustrated in FIG. 5. The estimation mode is a mode in which an estimated score is output using a learned learning model, that is, a function approximator to which learned learning model data is applied. That is, in the estimation mode, the device in which the learning device 1 and the estimation device 2 are integrated executes the processing illustrated in FIG. 7.

The learning device 1 and the estimation device 2 according to the above-described embodiment may be implemented by a computer. In that case, a program for implementing these functions may be recorded in a computer-readable recording medium, and the program recorded in the recording medium may be read and executed by a computer system to implement the functions. The “computer system” mentioned herein includes an OS and hardware such as a peripheral device. The “computer-readable recording medium” refers to a portable medium such as a flexible disk, a magneto-optical disc, a ROM, or a CD-ROM, or a storage device such as a hard disk included in the computer system. The “computer-readable recording medium” may include a medium that dynamically stores the program for a short time, such as a communication line in a case where the program is transmitted via a network such as the Internet or a communication line such as a telephone line, and a medium that stores the program for a certain period of time, such as a volatile memory inside the computer system serving as a server or a client in that case. Also, the foregoing program may be for implementing some of the functions described above, may be implemented in a combination of the functions described above and a program already recorded in a computer system, or may be implemented with a programmable logic device such as a field programmable gate array (FPGA).

Although the embodiment of the present invention has been described in detail with reference to the drawings, specific configurations are not limited to the embodiment and include design and the like without departing from the gist of the present invention.

### INDUSTRIAL APPLICABILITY

It can be used for scoring a competition in sports.

### REFERENCE SIGNS LIST

1 Learning device
11 Input unit
12 Learning unit
13 Learning processing unit
14 Function approximator
15 Learning model data storage unit
2 Estimation device
21 Input unit
22 Estimation unit
23 Learning model data storage unit

1. A learning device comprising:
a processor; and
a storage medium having computer program instructions stored thereon, when executed by the processor, perform to:
generates learning model data in a learning model that inputs original video data in which a background and a motion of a competitor are recorded, competitor mask video data in which an area surrounding the competitor is masked in each of a plurality of image frames included in the original video data, and background mask video data in which an area other than the area surrounding the competitor is masked in each of a plurality of image frames included in the original video data, in a case where the original video data is input, outputs a true value competition score that is an evaluation value for a competition of the competitor, in a case where the competitor mask video data is input, outputs an arbitrarily determined true value background score, and in a case where the background mask video data is input, outputs an arbitrarily determined true value competitor score.

2. The learning device according to claim 1,
includes a function approximator, learning processing is performed such that an estimated competition score obtained as an output value of the function approximator when the original video data is provided to the function approximator approaches the true value competition score, learning processing is performed such that an estimated background score obtained as an output value of the function approximator when the competitor mask video data is provided to the function approximator approaches the true value background score, and learning processing is performed such that an estimated competitor score obtained as an output value of the function approximator when the background mask video data is provided to the function approximator approaches the true value competitor score to generate the learning model data by updating a coefficient to be applied to the function approximator.

3. The learning device according to claim 2, wherein the computer program instructions further perform to
sets, as the new true value background score, an estimated background score obtained as an output value of the function approximator when the competitor mask video data is provided to the function approximator at an arbitrary timing in the middle of the learning processing, and sets, as the new true value competitor score, an estimated competitor score obtained as an output value of the function approximator when the background mask video data is provided to the function approximator.

4. The learning device according to claim 1, wherein the true value competition score is defined as a score of a scoring result of a competition recorded in the original video data, the true value background score is defined as a score in a case where the competition is not evaluated, and the true value competitor score is defined as the true value competition score.

5. An estimation device comprising:
an input unit that captures video data to be evaluated in which a motion of a competitor is recorded; and
an estimation unit that estimates an estimated competition score for the video data to be evaluated based on a learned learning model that inputs original video data in which a background and a motion of a competitor are recorded, competitor mask video data in which an area surrounding the competitor is masked in each of a plurality of image frames included in the original video data, and background mask video data in which an area other than the area surrounding the competitor is masked in each of a plurality of image frames included in the original video data, in a case where the original video data is input, outputs a true value competition score that is an evaluation value for a competition of the competitor, in a case where the competitor mask video data is input, outputs an arbitrarily determined true value background score, and in a case where the background mask video data is input, outputs an arbitrarily determined true value competitor score, and the video data to be evaluated captured by the input unit.

6. (canceled)

7. An estimating method comprising:
capturing video data to be evaluated in which a motion of a competitor is recorded; and
estimating an estimated competition score for the video data to be evaluated based on a learned learning model that inputs original video data in which a background and a motion of a competitor are recorded, competitor mask video data in which an area surrounding the competitor is masked in each of a plurality of image frames included in the original video data, and background mask video data in which an area other than the area surrounding the competitor is masked in each of a plurality of image frames included in the original video data, in a case where the original video data is input, outputs a true value competition score that is an evaluation value for a competition of the competitor, in a case where the competitor mask video data is input, outputs an arbitrarily determined true value background score, and in a case where the background mask video data is input, outputs an arbitrarily determined true value competitor score, and the captured video data to be evaluated.

8. A non-transitory computer-readable medium having computer-executable instructions that, upon execution of the instructions by a processor of a computer, cause the computer to function as the learning device according to claim 1.
